(19) United States
(12) Patent Application Publication
(10) Pub. No.: US 2011/0307188 A1
(43) Pub. Date: Dec. 15, 2011

(54) SYSTEMS AND METHODS FOR PROVIDING DRIVER FEEDBACK USING A HANDHELD MOBILE DEVICE

(75) Inventors: Jufeng Peng, Normal, IL (US); Brian Fields, Normal, IL (US); Paul Rutkowski, Normal, IL (US); Benjamin Bowne, Mackinaw, IL (US)

(73) Assignee: State Farm Insurance, Bloomington, IL (US)

(21) Appl. No.: 13/172,240

(22) Filed: Jun. 29, 2011

(51) Int. Cl. G06F 19/00

(52) U.S. Cl. 702/33

(57) ABSTRACT

A method for collecting and evaluating driving related data, comprising using one or more sensors associated with a handheld mobile device to automatically collect driving data during a data collection session; and using one or more processors to execute computer readable instructions stored in non-transitory memory to calculate, based at least on the collected driving data, one or more metrics related to the driver's driving behavior, and display on a display device the one or more calculated metrics related to the driver's driving behavior.

### TECHNICAL FIELD

The present disclosure relates generally to systems and methods for collecting and evaluating driving behavior data and/or driving environment data, and providing feedback based on such evaluated data. Aspects of the data collection, evaluation, and/or feedback may be provided by a handheld mobile device, e.g., a smart phone.

### BACKGROUND

Improvements in roadway and automobile designs have steadily reduced injury and death rates in developed countries. Nevertheless, auto collisions are still the leading cause of injury-related deaths, an estimated total of 1.2 million worldwide in 2004, or 25% of the total from all causes. Further, driving safety is particularly important for higher-risk drivers such as teens and elderly drivers, as well as higher-risk passengers such as infant and elderly passengers. For example, motor vehicle crashes are the number one cause of death for American teens.

Thus, driving safety remains a critical issue in today's society. Various efforts and programs have been initiated to improve driving safety over the years. For example, driving instruction courses (often referred to as “drivers ed”) are intended to teach new drivers not only how to drive, but how to drive safely. Typically, an instructor rides as a passenger and provides instruction to the learning driver, and evaluates the driver's performance. As another example, “defensive driving” courses aim to reduce the driving risks by anticipating dangerous situations, despite adverse conditions or the mistakes of others. This can be achieved through adherence to a variety of general rules, as well as the practice of specific driving techniques. Defensive driving course provide a variety of benefits. For example, in many states, a defensive driving course can be taken as a way to dismiss traffic tickets, or to qualify the driver for a discount on car insurance premiums.

From the perspective of an automobile insurance provider, the provider seeks to assess the risk level associated with a driver and price an insurance policy to protect against that risk. The process of determining the proper cost of an insurance policy, based on the assessed risk level, is often referred to as “rating.” The rating process may include a number of input variables, including experience data for the specific driver, experience data for a class of drivers, capital investment predictions, profit margin targets, and a wide variety of other data useful for predicting the occurrence of accidents as well as the amount of damage likely to result from such accidents.

### SUMMARY

In accordance with the teachings of the present disclosure, disadvantages and problems associated with existing systems and methods have been reduced.

According to one aspect of the invention, a method for collecting and evaluating driving related data is provided. One or more sensors associated with a handheld mobile device are used to automatically collect driving data during a data collection session. Computer readable instructions stored in non-transitory memory are executed by one or more processors to calculate, based at least on the collected driving data, one or more metrics related to the driver's driving behavior, and display on a display device the one or more calculated metrics related to the driver's driving behavior.

A further aspect of the invention provides a system for collecting and evaluating driving related data. The system includes a handheld mobile device including one or more sensors, a processor, a non-transitory storage medium, a display device, and a set of computer readable instructions stored in the non-transitory storage medium. The computer readable instructions are executable by the processor configured to calculate, based at least on the collected driving data, one or more metrics related to the driver's driving behavior, and display on the display device the one or more calculated metrics related to the driver's driving behavior.

A further aspect of the invention provides a non-transitory computer readable medium containing a set of computer readable instructions executable by a processor to receive driving data collected by one or more sensors associated with a handheld mobile device during a data collection session; calculate, based at least on the collected driving data, one or more metrics related to the driver's driving behavior; and display on a display device the one or more calculated metrics related to the driver's driving behavior.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example handheld mobile device located in a vehicle, the handheld mobile device including a driving analysis system, according to certain embodiments of the present disclosure;

FIG. 2 illustrates example components of the handheld mobile device relevant to the driving analysis system, according to certain embodiments;

FIG. 3 illustrates an example method of collecting and processing driving data, according to certain embodiments;

FIG. 4 illustrates an example method of collecting and processing driving data using example algorithms, according to certain embodiments;

FIG. 5 illustrates an example system for sharing driving data between a handheld mobile device including a driving analysis system and other external devices, according to certain embodiments;

FIGS. 6A-6G illustrate example screen shots generated by an example driving analysis application on a handheld mobile device, according to certain embodiments;

FIG. 7 is a flow chart of an illustrative algorithm for determining severity levels of notable driving events (NDE) identified during data collection sessions; and

FIG. 8 is a flow chart of an illustrative algorithm for determining severity levels of notable driving events (NDE) identified during data collection sessions.

### DETAILED DESCRIPTION

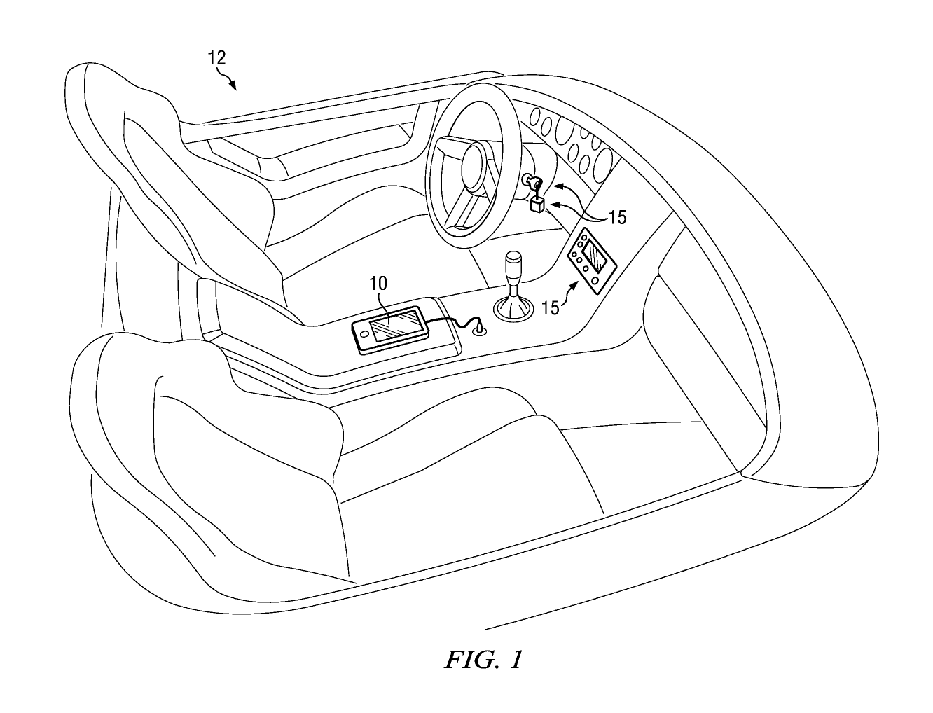

Preferred embodiments and their advantages over the prior art are best understood by reference to FIGS. 1-8 below. The present disclosure may be more easily understood in the context of a high level description of certain embodiments.

FIG. 1 illustrates an example handheld mobile device 10 located in a vehicle 12, according to certain embodiments or implementations of the present disclosure. Handheld mobile device 10 may comprise any type of portable or mobile electronics device, such as for example a mobile telephone, personal digital assistant (PDA), laptop computer, tablet-style computer such as the iPad by Apple Inc., or any other portable electronics device. For example, in some embodiments, handheld mobile device 10 may be a smart phone, such as an iPhone by Apple Inc., a Blackberry phone by RIM, a Palm phone, or a phone using an Android, Microsoft, or Symbian operating system (OS), for example.

In some embodiments, handheld mobile device 10 may be configured to provide one or more features of a driving analysis system, such as (a) collection of driving data (e.g., data regarding driving behavior and/or the respective driving environment), (b) processing of collected driving data, and/or (c) providing feedback based on the processed driving data. Accordingly, handheld mobile device 10 may include one or more sensors, a driving analysis application, and a display.

The sensor(s) may collect one or more types of data regarding driving behavior and/or the driving environment. For example, handheld mobile device 10 may include a built-in accelerometer configured to detect acceleration in one or more directions (e.g., in the x, y, and z directions). As another example, handheld mobile device 10 may include a GPS (global positioning system) device or any other device for tracking the geographic location of the handheld mobile device. As another example, handheld mobile device 10 may include sensors, systems, or applications for collecting data regarding the driving environment, e.g., traffic congestion, weather conditions, roadway conditions, or driving infrastructure data. In addition or alternatively, handheld mobile device 10 may collect certain driving data (e.g., driving behavior data and/or driving environment data) from sensors and/or devices external to handheld mobile device 10 (e.g., speed sensors, blind spot information sensors, seat belt sensors, GPS device, etc.).

The driving analysis application on handheld mobile device 10 may process any or all of this driving data collected by handheld mobile device 10 and/or data received at handheld mobile device 10 from external sources to calculate one or more driving behavior metrics and/or scores based on such collected driving data. For example, driving analysis application may calculate acceleration, braking, and cornering metrics based on driving behavior data collected by the built-in accelerometer (and/or other collected data). Driving analysis application may further calculate scores based on such calculated metrics, e.g., an overall driving score. As another example, driving analysis application may identify “notable driving events,” such as instances of notable acceleration, braking, and/or cornering, as well as the severity of such events. In some embodiments, the driving analysis application may account for environmental factors, based on collected driving environment data corresponding to the analyzed driving session(s). For example, the identification of notable driving events may depend in part on environmental conditions such as the weather, traffic conditions, road conditions, etc. Thus, for instance, a particular level of braking may be identified as a notable driving event in the rain, but not in dry conditions.

The driving analysis application may display the processed data, e.g., driving behavior metrics and/or driving scores. In embodiments in which handheld mobile device 10 includes a GPS or other geographic location tracking device, the application may also display a map showing the route of a trip, and indicating the location of each notable driving event. The application may also display tips to help drivers improve their driving behavior.

The driving analysis application may display some or all of such data on the handheld mobile device 10 itself. In addition or alternatively, the driving analysis application may communicate some or all of such data via a network or other communication link for display by one or more other computer devices (e.g., smart phones, personal computers, etc.). Thus, for example, a parent or driving instructor may monitor the driving behavior of a teen or student driver without having to access the handheld mobile device 10. As another example, an insurance company may access driving behavior data collected/processed by handheld mobile device 10 and use such data for risk analysis of a driver and determining appropriate insurance products or premiums for the driver according to such risk analysis (i.e., performing rating functions based on the driving behavior data collected/processed by handheld mobile device 10).

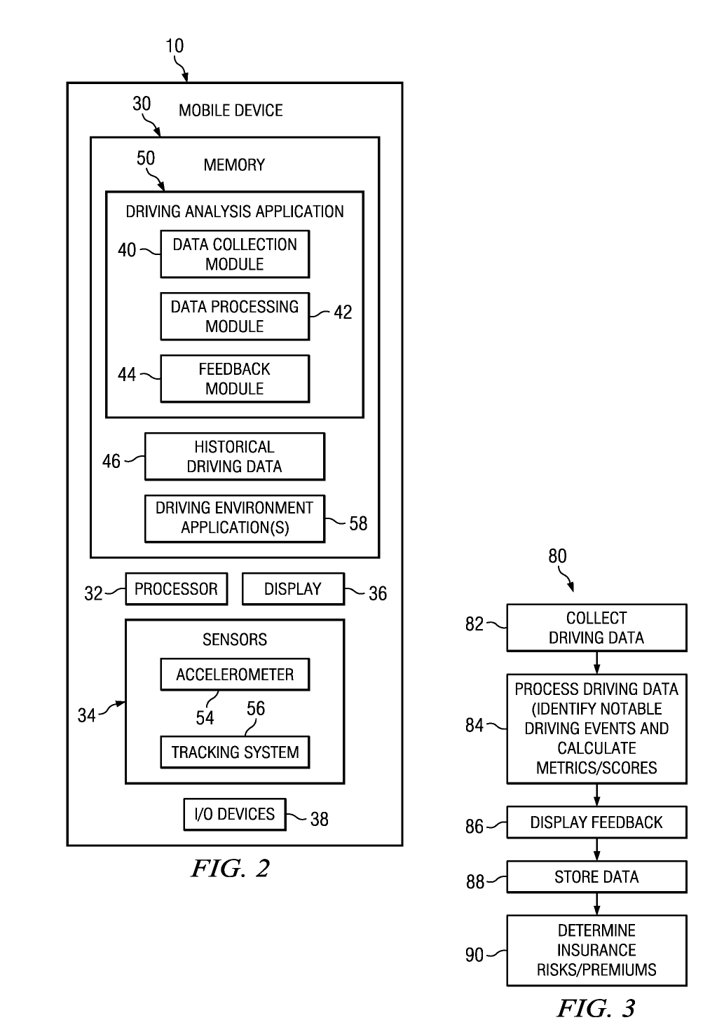

FIG. 2 illustrates example components of handheld mobile device 10 relevant to the driving analysis system discussed herein, according to certain embodiments. As shown, handheld mobile device 10 may include a memory 30, processor 32, one or more sensors 34, a display 36, and input/output devices 38.

Memory 30 may store a driving analysis application 50 and historical driving data 46, as discussed below. In some embodiments, memory 30 may also store one or more environmental data applications 58, as discussed below. Memory 30 may comprise any one or more devices suitable for storing electronic data, e.g., RAM, DRAM, ROM, internal flash memory, external flash memory cards (e.g., Multi Media Card (MMC), Reduced-Size MMC (RS-MMC), Secure Digital (SD), MiniSD, MicroSD, Compact Flash, Ultra Compact Flash, Sony Memory Stick, etc.), SIM memory, and/or any other type of volatile or non-volatile memory or storage device. Driving analysis application 50 may be embodied in any combination of software, firmware, and/or any other type of computer-readable instructions.

Application 50 and/or any related, required, or useful applications, plug-ins, readers, viewers, updates, patches, or other code for executing application 50 may be downloaded via the Internet or installed on handheld mobile device 10 in any other known manner.

Processor 32 may include a microprocessor, a microcontroller, a digital signal processor (DSP), an application specific integrated controller (ASIC), electrically-programmable read-only memory (EPROM), or a field-programmable gate array (FPGA), or any other suitable processor(s), and may be generally operable to execute driving analysis application 50, as well as providing any other functions of handheld mobile device 10.

Sensors 34 may include any one or more devices for detecting information regarding a driver's driving behavior and/or the driving environment. For example, as discussed above, sensors 34 may include an accelerometer 54 configured to detect acceleration of the handheld mobile device 10 (and thus, the acceleration of a vehicle in which handheld mobile device 10 is located) in one or more directions, e.g., the x, y, and z directions. As another example, handheld mobile device 10 may include a location tracking system 56, such as a GPS tracking system or any other system or device for tracking the geographic location of the handheld mobile device. A solid state compass, with two or three magnetic field sensors, may provide data to a microprocessor to calculate direction using trigonometry. The handheld mobile device 10 may also include proximity sensors, a camera or ambient light.

Display 36 may comprise any type of display device for displaying information related to driving analysis application 50, such as for example, an LCD screen (e.g., thin film transistor (TFT) LCD or super twisted nematic (STN) LCD), an organic light-emitting diode (OLED) display, or any other suitable type of display. In some embodiments, display 36 may be an interactive display (e.g., a touch screen) that allows a user to interact with driving analysis application 50. In other embodiments, display 36 may be strictly a display device, such that all user input is received via other input/output devices 38.

Input/output devices 38 may include any suitable interfaces allowing a user to interact with handheld mobile device 10, and in particular, with driving analysis application 50. For example, input/output devices 38 may include a touchscreen, physical buttons, sliders, switches, data ports, keyboard, mouse, voice activated interfaces, or any other suitable devices.

As discussed above, driving analysis application 50 may be stored in memory 30. Driving analysis application 50 may be described in terms of functional modules, each embodied in a set of logic instructions (e.g., software code). For example, as shown in FIG. 2, driving analysis application 50 may include a data collection module 40, a data processing module 42, and a feedback module 44.

Data collection module 40 may be operable to manage the collection of driving data, including driving behavior data and/or the driving environment data. Data collection module 40 may collect such data from any number and types of data sources, including (a) data sources provided by handheld mobile device 10 (e.g., sensors 34, environmental data application 58), (b) data sources in vehicle 12 but external to handheld mobile device 10 (e.g., on-board vehicle computer, seat belt sensors, GPS system, etc.), and/or (c) data sources external to vehicle 12 (e.g., data sources accessible to handheld mobile device 100 by a satellite network or other telecommunication links). In certain embodiments, the handheld mobile device 10 may communicate with data source in vehicle 12 but external to handheld mobile device 10 via a hardwire connection, Bluetooth® or other wireless means, optical signal transmission, or any other known manner. Sources in vehicle 12 but extended to handheld mobile device 10 may include: engine RPM, speedometer, fuel usage rate, exhaust components or other combination indications, suspension system monitors, seat belt use indicators, tracking systems for other vehicles in vicinity, blind spot indicators.

In some embodiments, data collection module 40 may control the start and stop of driving data collection, e.g., from sources such as accelerometer 54, location tracking system 56, other sensor(s) 34 provided by handheld mobile device 10, or other sensors or sources of driving data external to handheld mobile device 10. In some embodiments or situations, driving data collection is manually started and stopped by the driver or other user, e.g., by interacting with a physical or virtual object (e.g., pressing a virtual “start recording” button) on handheld mobile device 10.

In other embodiments or situations, data collection module 40 may automatically start and/or stop collection of driving data in response to triggering signals received by handheld mobile device 10 from one or more triggering devices 15 associated with vehicle 12 (see FIG. 1). For example, triggering device 15 may include a vehicle on-board computer, ignition system, car stereo, GPS system, a key, key fob, or any other device that may be configured to communicate signals to handheld mobile device 10. Triggering signals may include any signals that may indicate the start or stop of a driving trip. For example, triggering signals may include signals indicating the key has been inserted into or removed from the ignition, signals indicating the ignition has been powered on/off, signals indicating whether the engine is running, signals indicating the radio has been powered on/off, etc. or signals indicating the transmission has been set in a forward gear position. Such triggering device(s) may communicate with handheld mobile device 10 in any suitable manner, via any suitable wired or wireless communications link. As another example, data collection module 40 may automatically start and/or stop collection of driving data in response to determining that the handheld mobile device 10 is likely travelling in an automobile, e.g., based on a real time analysis of data received from accelerometer 54, location tracking system 56, or other sensors 34 provided by handheld mobile device 10. For example, data collection module 40 may include algorithms for determining whether handheld mobile device 10 is likely travelling in an automobile based on data from accelerometer 54 and/or location tracking system 56, e.g., by analyzing one or more of (a) the current acceleration of handheld mobile device 10 from accelerometer 54, (b) the current location of handheld mobile device 10 from location tracking system 56 (e.g., whether handheld mobile device 10 is located on/near a roadway), (c) the velocity of handheld mobile device 10 from location tracking system 56, (d) any other suitable data, or (e) any combination of the preceding.

In some embodiments or situations, data collection module 40 may allow or trigger the start and stop (including interrupting and re-starting) of driving data collection based on the orientation of handheld mobile device 10 (relative to automobile 12), e.g., based on whether the orientation is suitable for collecting driving data. For example, data collection module 40 may allow driving data collection to be manually or automatically started (or re-started after an interruption) only if the physical orientation of handheld mobile device 10 is suitable for collecting driving data, according to predefined rules. Further, during driving data collection, module 40 may automatically stop or interrupt the driving data collection if handheld mobile device 10 is moved such that it is no longer suitably oriented for collecting driving data.

Thus, in such embodiments, data collection module 40 may manage the physical orientation of handheld mobile device 10 within the vehicle. Module 40 may determine the orientation of handheld mobile device 10 within the vehicle by comparing GPS and position information for the handheld mobile device 10 with GPS and position information for the vehicle 12. This comparison of data may allow the user to adjust the handheld mobile device 10 such that the orientation of handheld mobile device 10 is suitable for collecting driving data. For example, data collection module 40 may determine the orientation of handheld mobile device 10; determine whether the orientation is suitable for collecting driving data; if so, allow data collection to begin or continue; and if not, instruct or notify the user to adjust the orientation of handheld mobile device 10 (e.g., by indicating the direction and/or extent of the desired adjustment). Once handheld mobile device 10 has been adjusted to a suitable orientation for collecting driving data, module 40 may notify the user and allow data collection to begin or continue. Module 40 may continue to monitor the orientation of handheld mobile device 10 relative to the vehicle during the driving data collection session, and if a change in the orientation is detected, interact with the user to instruct a correction of the orientation.

In other embodiments, handheld mobile device 10 is capable of automatically compensating for the orientation of handheld mobile device 10 for the purposes of processing collected driving data (e.g., by data processing module 42), such that data collection may start and continue despite the orientation of handheld mobile device 10. Module 40 may continue to monitor the orientation of handheld mobile device 10 relative to the vehicle during the driving data collection session, and if a change in the orientation is detected, automatically compensate for the changed orientation of handheld mobile device 10 for processing driving data collected from that point forward. In such embodiments, data processing module 42 may include any suitable algorithms for compensating for the orientation of handheld mobile device 10 (relative to automobile 12) determined by data collection module 40.

As used herein, the term “user” refers to the driver or other person interacting with driving analysis application 50 on handheld mobile device 10.

Data collection module 40 may collect data over one or more data collection sessions corresponding to one or more driving sessions. As used herein, a “driving session” may refer to any period of driving, which may comprise a single uninterrupted trip, a portion of a trip, or a series of multiple distinct trips. A “data collection session” may generally correspond to one driving session, a portion of a driving session, or multiple distinct driving sessions. Further, a data collection session may comprise an uninterrupted period of data collection or may include one or more interruptions (e.g., in some embodiments, if handheld mobile device 10 is moved out of proper orientation for data collection). Thus, in some embodiments, each interruption of data collection initiates a new data collection session; in other embodiments, e.g., where a data collection session generally corresponds to a driving trip, an interrupted data collection session may reconvene after the interruption.

Thus, based on the above, data collection module 40 may trigger or control the start and stop of data collection sessions and/or start and the stop of interruptions within a data collection session.

Any or all data collected by data collection module 40 may be time stamped (e.g., time and date), either by data collection module 40 itself or by another device that collected or processed particular data before sending the data to data collection module 40. The time stamping may allow for data from different sources (e.g., data from accelerometer 54, location tracking system 56, a seat belt sensor, etc.) to be synchronized for analyzing the different data together as a whole (e.g., to provide the driving context for a particular reading of accelerometer 54, as discussed below).

Data collection module 40 may collect data corresponding to physical parameters or characteristics of the car.

Data processing module 42 may be operable to process or analyze any of the driving data (e.g., driving behavior data and/or the driving environment data) collected by handheld mobile device 10 itself and/or collected by external devices and communicated to handheld mobile device 10, and based on such collected driving data, calculate one or more driving behavior metrics and/or scores. For example, data processing module 42 may calculate the driving behavior metrics of acceleration, braking, and/or cornering metrics based on driving behavior data collected by an accelerometer 54, location tracking system 56, and/or other collected data. Further, data processing module 42 may calculate one or more driving scores based on the calculated driving behavior metrics (e.g., acceleration, braking, cornering, etc.) and/or based on additional collected data, e.g., driving environment data collected by environmental data applications 58. For example, data processing module 42 may apply algorithms that calculate a driving score based on weighted values for each respective driving behavior metric, and environmental correction values based on the relevant driving environment data, such as weather, traffic conditions, road conditions, etc.

Data processing module 42 may calculate individual driving behavior metrics (e.g., acceleration, braking, cornering, etc.) and/or driving scores for individual data collection sessions. Similarly, data processing module 42 may calculate driving behavior metrics and/or driving scores corresponding to a group of data collection sessions, which may be referred to as group-session metrics/scores. Data processing module 42 may calculate group-session metrics/scores may using averaging, filtering, weighting, and/or any other suitable algorithms for determining representative metrics/scores corresponding to a group of data collection sessions. A “group” of data collection sessions may be specified in any suitable manner, for example:
The n most recent data collection sessions;
The n most recent data collection sessions corresponding to one or more specific driving conditions or other preset conditions, such as for example: nighttime driving, daytime driving, driving within specific times of day (e.g., specific hours), weekend driving, weekday driving, highway driving, city driving, rush-hour driving, good-weather driving, bad-weather driving, driving in specific weather conditions (e.g., rain, snow, etc.), trips of specified distances (e.g., trips shorter than a threshold distance, longer than a threshold distance, or within any present range of distances, trips associated with a certain geographic area (e.g., trips within or near a specific city), trips between specific points (e.g., trips between the driver's home and work, which may be determined for example by GPS data or entered into application 50 by the driver), trips following a specific route (e.g., which may be determined for example by GPS data or entered into application 50 by the driver), driving alone (e.g., which status may be entered into application 50 by the driver), driving with passengers (e.g., which status may be entered into application 50 by the driver),
All data collection sessions within a specified time period, e.g., all data collection sessions in the last day, week, 30 days, 90 days, year, or any other specified time period.
All data collection sessions within a specified time period that also correspond to one or more specific driving conditions or other preset conditions, e.g., any of the conditions listed above.
All data collection sessions after a particular starting point, e.g., all data collection sessions after a user initiates application 50, or after a user resets a particular average or filtered metric/score (or all average or filtered metrics/scores).
All data collection sessions within a specified time period that also correspond to one or more specific driving conditions or other preset conditions, e.g., any of the conditions listed above.
All data collection sessions related to a particular driver.
Any combination or variation of any of the above.
   The number n may be any multiple number (2, 3, 4, 5, etc.), which may be automatically determined by application 50, selected by a user, or otherwise determined or selected. Further, as mentioned briefly above, data processing module 42 may identify “notable driving events,” such as instances of notable acceleration, braking, and cornering, as well as the severity of such events. Data processing module 42 may identify notable driving events using any suitable algorithms. For example, an algorithm may compare acceleration data from accelerometer 54 (raw or filtered) to one or more predefined thresholds for notable acceleration, braking, or cornering. In some embodiments, data processing module 42 may analyze the acceleration data in combination with contextual data, which may provide a context for the acceleration data, and analyze the acceleration data based on the context data. Thus, for example, particular acceleration data may or may not indicate “notable acceleration” depending on the contextual data corresponding (e.g., based on time stamp data) to the particular acceleration data being analyzed. Data processing module 42 may utilize algorithms that analyze the acceleration data together with the relevant contextual data.

Contextual data may include, for example, location data and/or driving environment data. Module 42 may use location data (e.g., from location tracking system 56) in this context to determine, for example, the type of road the vehicle is travelling on, the speed limit, the location of the vehicle relative to intersections, traffic signs/light (e.g., stop signs, yield signs, traffic lights), school zones, railroad tracts, traffic density, or any other features or aspects accessible from location tracking system 56 that may influence driving behavior. Module 42 may use driving environment data (e.g., from environmental data applications 58) in this context to determine, for example, the relevant weather, traffic conditions, road conditions, etc. In some embodiments, data processing module 42 may apply different thresholds for determining certain notable driving events. For example, for determining instances of “notable cornering” based on acceleration data from accelerometer 54 and weather condition data (e.g., from sensors on the vehicle, sensors on handheld mobile device 10, data from an online weather application (e.g., www.weather.com), or any other suitable source), module 42 may apply different thresholds for identifying notable cornering in dry weather conditions, rainy weather conditions, and icy weather conditions. As another example, for determining instances of “notable braking” based on acceleration data from accelerometer 54 and location data (e.g., from a GPS system), module 42 may apply different thresholds for identifying notable braking for highway driving, non-highway driving, low-traffic driving, high-traffic driving, approaching a stop sign intersection, approaching a stop light intersection, etc.

Further, in some embodiments, data processing module 42 may define multiple levels of severity for each type (or certain types) of notable driving events. For example, module 42 may define the following levels of notable braking: (1) significant braking, and (2) extreme braking As another example, module 42 may define the following three progressively severe levels of particular notable driving events: (1) caution, (2) warning, and (3) extreme. Each level of severity may have corresponding thresholds, such that the algorithms applied by module 42 may determine (a) whether a notable event (e.g., notable braking event) has occurred, and (b) if so, the severity level of the event. Each type of notable driving event may have any number of severity levels (e.g., 1, 2, 3, or more).

In some embodiments, data processing module 42 may calculate the number of each type of notable driving events (and/or the number of each severity level of each type of notable driving event) for a particular time period, for individual data collection sessions, or for a group of data collection sessions (e.g., using any of the data collection session “groups” discussed above).

Feedback module 44 may be operable to display any data associated with application 50, including raw or filtered data collected by data collection module 40 and/or any of the metrics, scores, or other data calculated or proceed by data processing module 42. For the purposes of this description, unless otherwise specified, “displaying” data may include (a) displaying data on display device 36 of handheld mobile device 10, (b) providing audible feedback via a speaker of handheld mobile device 10, providing visual, audible, or other sensory feedback to the driver via another device in the vehicle (e.g., through the vehicle's radio or speakers, displayed via the dashboard, displayed on the windshield (e.g., using semi-transparent images), or using any other known techniques for providing sensory feedback to a driver of a vehicle, (d) communicating data (via a network or other wired or wireless communication link or links) for display by one or more other computer devices (e.g., smart phones, personal computers, etc.), or (e) any combination of the preceding. To provide feedback to the driver visual, audible, or other sensory feedback to the driver via a feedback device in the vehicle other than handheld mobile device 10, handheld mobile device 10 may include any suitable communication system for wired or wireless communication of feedback signals from handheld mobile device 10 to such feedback device.

Further, feedback module 44 may also initiate and/or manage the storage of any data associated with application 50, including raw or filtered data collected by data collection module 40 and/or any of the metrics, scores, or other data calculated or proceed by data processing module 42, such that the data may be subsequently accessed, e.g., for display or further processing. For example, feedback module 44 may manage short-term storage of certain data (e.g., in volatile memory of handheld mobile device 10), and may further manage long-term storage of certain data as historical driving data 46 (e.g., in non-volatile memory of handheld mobile device 10). As another example, feedback module 44 may communicate data associated with application 50 via a network or other communication link(s) to one or more other computer devices, e.g., for display by remote computers 150 and/or for storage in a remote data storage system 152, as discussed in greater detail below with reference to FIG. 5.

Feedback module 44 may be operable to display metrics, scores, or other data in any suitable manner, e.g., as values, sliders, icons (e.g., representing different magnitudes of a particular metric/score value using different icons or using different colors or sizes of the same icon), graphs, charts, etc. Further, in embodiments in which handheld mobile device 10 includes a GPS or other location tracking system 56, feedback module 44 may display one or more maps showing the route traveled during one or more data collection sessions or driving sessions, and indicating the location of “notable driving events.” Notable driving events may be identified on the map in any suitable manner, e.g., using representative icons. As an example only, different types of notable driving events (e.g., notable acceleration, notable braking, and notable cornering) may be represented on the map with different icons, and the severity level of each notable driving event may be indicated by the color and/or size of each respective icon.

Feedback module 44 may also display tips to help drivers improve their driving behavior. For example, feedback module 44 may analyze the driver's driving behavior metrics and/or driving scores to identify one or more areas of needed improvement (e.g., braking or cornering) and display driving tips specific to the areas of needed improvement.

In some embodiments, feedback module 44 may provide the driver real time feedback regarding notable driving events, via any suitable form of feedback, e.g., as listed above. For example, feedback module 44 may provide audible feedback (e.g., buzzers or other sound effects, or by human recorded or computer-automated spoken feedback) through a speaker of handheld mobile device 10 or the vehicle's speakers, or visual feedback via display 36 of handheld mobile device 10 or other display device of the vehicle. Such real-time audible or visual feedback may distinguish between different types of notable driving events and/or between the severity level of each notable driving event, in any suitable manner. For example, spoken feedback may indicate the type and severity of a notable driving event in real time. Non-spoken audible feedback may indicate the different types and severity of notable driving events by different sounds and/or different volume levels.

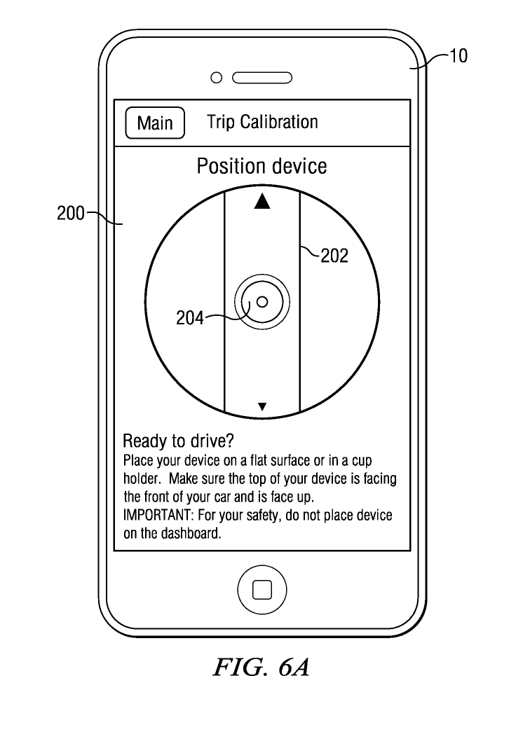

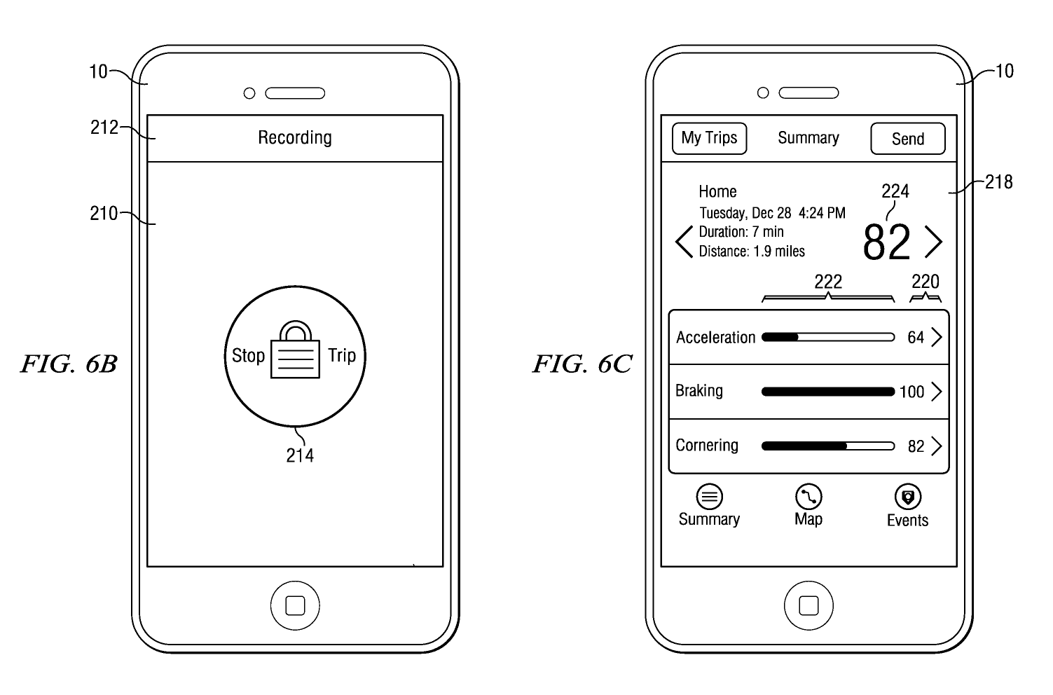

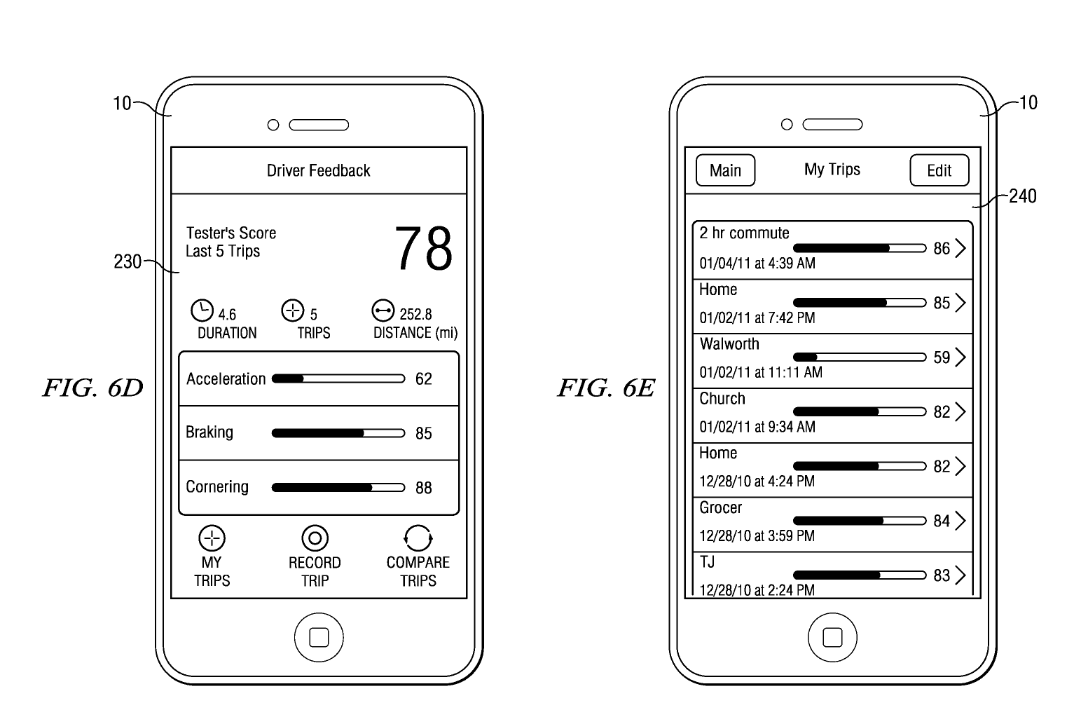

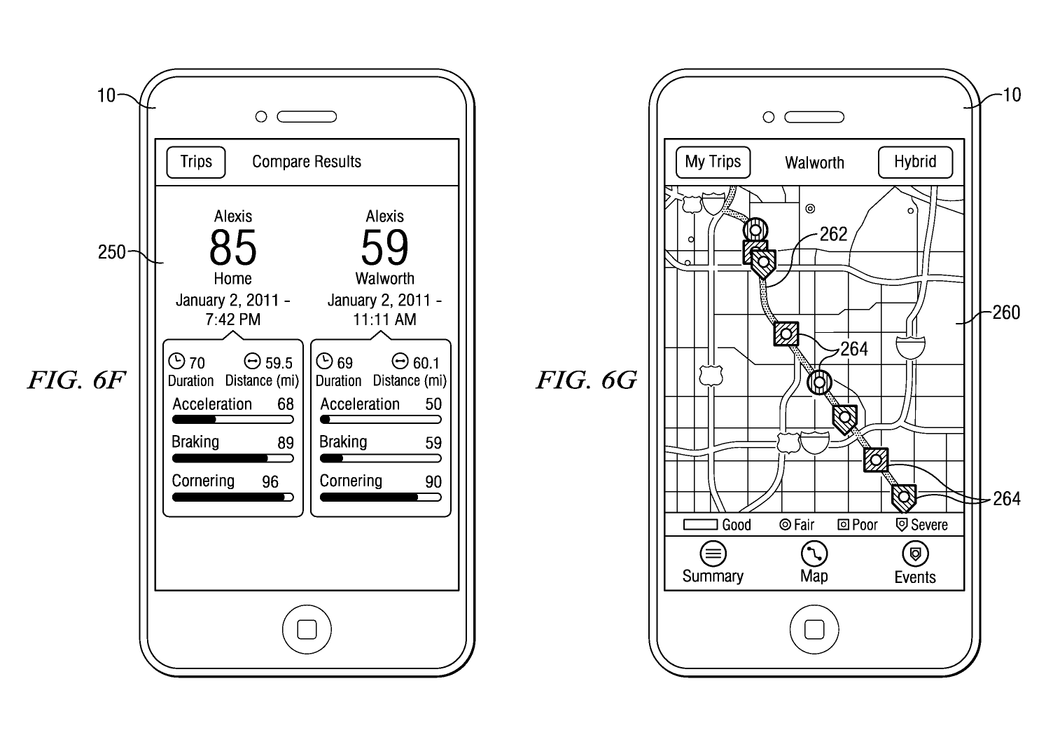

Feedback module 44 may manage user interactions with application 50 via input/output devices 38 (e.g., a touchscreen display 36, keys, buttons, and/or other user interfaces). For example, feedback module 44 may host a set or hierarchy of displayable objects (e.g., screens, windows, menus, images etc.) and facilitate user navigation among the various objects. An example set of displayable objects, in the form of screens, is shown and discussed below with reference to FIGS. 6A-6G.

Environmental data applications 58 may comprise any applications or interfaces for collecting driving environment data regarding the driving environment corresponding to a driving data collection session. For example, environmental data applications 58 may comprise any applications or interfaces operable to collect data from one or more sensors on vehicle 12 or from one or more devices external to vehicle 12 (via a network or communication links) regarding the relevant driving environment. For example, such driving environment data may include any of (a) traffic environment characteristics, e.g., congestion, calmness, or excitability of traffic, quantity and type of pedestrian traffic, etc., (b) weather environment characteristics, e.g., ambient temperature, precipitation, sun glare, darkness, etc., (c) roadway environment characteristics, e.g., curvature, skid resistance, elevation, gradient and material components, etc., (d) infrastructure environment characteristics, e.g., lighting, signage, type of road, quantity and type of intersections, lane merges, lane markings, quantity and timing of traffic lights, etc., and/or (e) any other type of driving environment data.

According to some embodiments of the invention, data collection module 40 collects information and data sufficient to enable the data processing module 42 to analyze how driving has impacted fuel efficiency. The feedback module 44 may report notable driving events that had positive or negative impact on the fuel efficiency of the vehicle 12. For example, if the vehicle 12 has a normal transmission and the driver allows the engine to reach excessive RPMs before shifting to a higher gear, each occurrence may be reported as a notable driving event that impacts fuel efficiency. The feedback may assist the driver to develop driving habits that enable more fuel efficient vehicle operation.

FIG. 3 illustrates an example method 80 of providing driver feedback, according to certain embodiments. Any or all of the steps of method 80 may be performed by the various modules of driving analysis application 50.

At step 82, data collection module 40 may collect driving data during a data collection session (which may correspond to a driving trip, a portion of a driving trip, or multiple driving trips). The collected driving data may include, e.g., driving behavior data collected by accelerometer 54, location tracking system 56, etc. and/or driving environment data collected by environmental data applications 58. The collected driving data may also include driving behavior data and/or driving environment data collected by external devices and communicated to handheld mobile device 10.

Data collection module 40 may control the start and stop of the data collection session either manually or automatically, as discussed above. In some embodiments, this may include interacting with the user (driver or other person) to manage the physical orientation of handheld mobile device 10 in order to allow the driving data collection to begin (or re-start after an interruption), as discussed above.

At step 84, data processing module 42 may process or analyze any or all of the driving data collected at step 82, and calculate one or more driving behavior metrics and/or scores corresponding to the data collection session, e.g., as discussed above. In addition, data processing module 42 may identify “notable driving events” (NDEs) and determine the severity of such events, e.g., as discussed above. In some embodiments, data processing module 42 may process the collected data in real time or substantially in real time. In other embodiments, data processing module 42 may process the collected data after some delay period, upon the end of the data collection session, in response to a request by a user (e.g., a user of handheld mobile device 10, a user at remote computer 150, or other user), upon collection of data for a preset number of data collection session, or at any other suitable time or in response to any other suitable event.

In some embodiments, data processing module 42 may calculate one or more individual driving behavior metrics (e.g., acceleration, braking, cornering, etc.) and/or driving scores for the current or most recent data collection session. Further, data processing module 42 may calculate one or more individual driving behavior metrics and/or driving scores for multiple data collection sessions. For example, data processing module 42 may calculate filtered or averaged driving behavior metrics and/or driving scores for a group of data collection sessions (e.g., as discussed above), including the current or most recent data collection session.

At step 86, feedback module 44 may display any of the data collected by data collection module 40 at step 82 (e.g., raw data or filtered raw data) and/or any of the metrics, scores, or other data calculated or proceed by data processing module 42 at step 84. This may include any manner of “displaying” data as discussed above, e.g., displaying data on display device 36, providing visual, audible, or other sensory feedback to the driver via handheld mobile device 10 or other device in the vehicle, communicating data to remote computer devices for remote display, etc. In some embodiments, feedback module 44 may facilitate user interaction with application 50 (e.g., via a touchscreen display 36 or other input devices 38) allowing the user to view any of the data discussed above, e.g., by user selection or navigation of displayed objects).

At step 88, feedback module 44 may initiate and/or manage the storage of any of the data collected by data collection module 40 at step 82 (e.g., raw data or filtered raw data) and/or any of the metrics, scores, or other data calculated or proceed by data processing module 42 at step 84, such that the stored data may be subsequently accessed, e.g., for display or further processing. For example, feedback module 44 may store data in local volatile memory for display, in local non-volatile memory as historical driving data 46, and/or in remote memory as historical driving data 152.

As shown in FIG. 3, method 80 may then return to step 82 for the collection of new driving data. It should be understood that the steps shown in FIG. 3 may be performed in any suitable order, and additional steps may be included in the process. Further, certain steps may be performed continuously (e.g., the data collection step 82 may continue throughout the data collection process). Further, multiple steps may be performed partially or fully simultaneously.

In some embodiments, steps 82-88 (or at least portions of such steps) may be executed in real time or substantially in real time such that steps 82-88 are continuously performed, or repeated, during a particular data collection session. In such embodiments, at step 86 data may be prepared for subsequent display rather than being displayed in real time, while the process continues to collect, process, and store new driving data. However, as discussed above, certain feedback may be provided at step 86 in real time, e.g., real time feedback indicating the occurrence of notable driving events. In other embodiments, one or more steps may not be performed in real time. For example, some or all of the processing, display, and storage steps may be performed after the completion of the data collection session, e.g., when more processing resources may be available. For instance, collected raw data may be stored in first memory (e.g., cache or other volatile memory) during the data collection session; and then after the end of the data collection session, the collected data may be processed, displayed, stored in second memory (e.g., stored in non-volatile memory as historical driving data 46), and/or communicated to remote entities for storage, processing, and/or display.

As discussed above, in some embodiments, driving data collected by application 50 may be used by various third parties for various purposes. Thus, for example, at step 90, an insurance provider may receive or access driving behavior metrics and/or driving scores collected by application 50 (e.g., by receiving or accessing historical driving data 46 directly from handheld mobile device 10 and/or by receiving or accessing historical driving data 152 from external storage), and analyze such data for performing risk analysis of the respective driver. The insurance provider may determine appropriate insurance products or premiums for the driver according to such risk analysis.

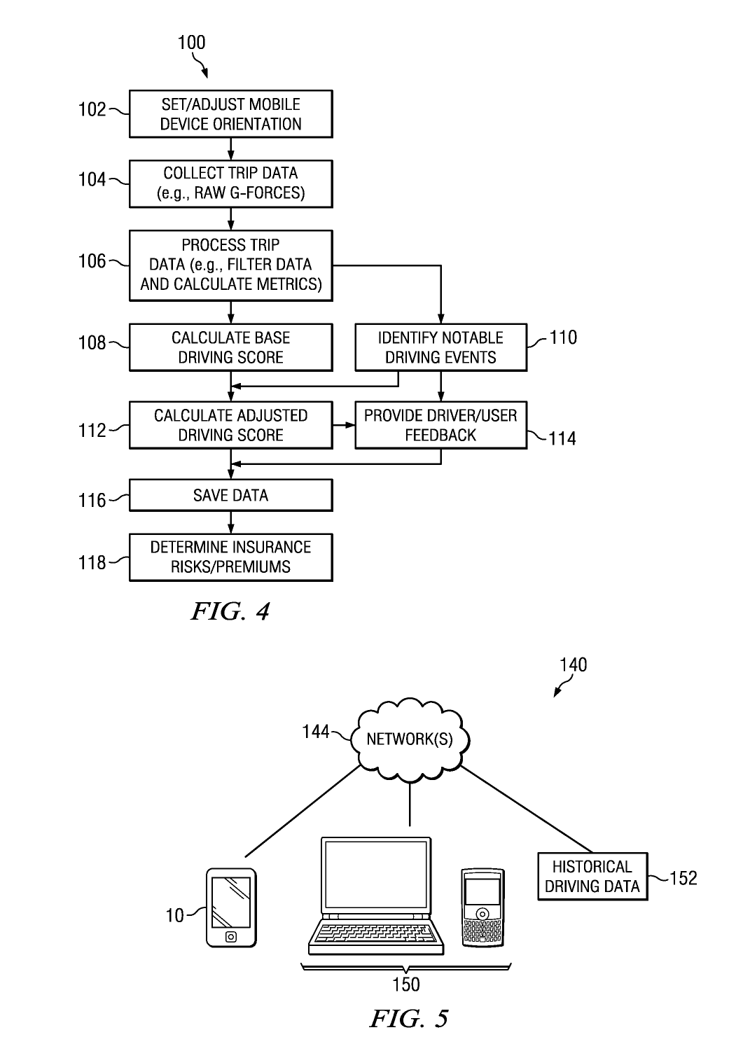

FIG. 4 illustrates an example method 100 of providing driver feedback using example algorithms, according to certain embodiments. Any or all of the steps of method 100 may be performed by the various modules of driving analysis application 50.

At step 102, data collection module 40 may interact with the user to adjust the handheld mobile device 10 such that the orientation of handheld mobile device 10 is suitable for collecting driving data. For example, data collection module 40 may instruct the user to position the handheld mobile device 10 towards the front of the vehicle and with the top end of the handheld mobile device 10 facing the front of the vehicle.

Once data collection module 40 determines that handheld mobile device 10 is properly oriented, data collection module 40 may begin collecting driving data, i.e., start a data collection session, at step 104. For example, data collection module 40 may begin collecting raw G-force data (i.e., acceleration data) from built-in accelerometer 54. The collected G-force data may provide data for multiple different acceleration directions, e.g., lateral G-force data regarding lateral acceleration and longitudinal G-force data regarding longitudinal acceleration. Module 40 may time stamp the collected data. Further, module 40 may filter or truncate the beginning and end of the data collection session, the extent of which filtering or truncation may depend on the length of the data collection session. For example, if the data collection session exceeds 4 minutes, module 40 may erase data collected during the first and last 60 seconds of the data collection session; whereas if the data collection session does not exceed 4 minutes, module 40 may erase data collected during the first and last 3 seconds of the data collection session. The particular values of 4 minutes, 60 seconds, and 3 seconds are example values only; any other suitable values may be used.

At step 106, data processing module 42 may process the collected driving data. For example, module 42 may calculate a one-second moving average of the G-force. Thus, if the data collection is for instance 5 Hz, the 5-step moving average may be calculated.

Module 42 may then calculate the “jerk” at each time stamp Tᵢ wherein jerk at a particular time stamp Tⱼ is defined as follows:

Jerk=abs(moving averaged G-force at time stamp Tⱼ−moving averaged G-force at time stamp Tⱼ₋₁)/unit_time(1 second)

### (Alternatively, Jerk May be Calculated Using Raw G-Forces Data Instead of Averaged G-Force Data.)

Module 42 may then calculate the one-second moving average of the jerk.

Module 42 may then determine one or more driving behavior metrics based on the moving averaged jerk and G-force data. For example, module 42 may determine a G-force percentile and a jerk percentile at each time stamp Tᵢ by accessing look-up tables corresponding to one or more relevant parameters. For instance, a portion of an example look-up table for an example set of relevant parameters is provided below:
Relevant Parameters:
   Vehicle: Impala
   Vehicle type: Sedan
   Acceleration direction (lateral or longitudinal): Lateral
   Type of data (G-force or Jerk): G-force
   Speed range: 0-100 mph

TABLE 1
G-force Percentile Look-Up Table

| | |
|---|---|
| G-force range | Percentile |

| | | |
|---|---|---|
| 0.000 | 0.012 | 0 |
| 0.013 | 0.025 | 1 |
| 0.026 | 0.038 | 2 |
| 0.039 | 0.051 | 3 |
| 0.052 | 0.064 | 4 |
| 0.065 | 0.077 | 5 |
| 0.078 | 0.090 | 6 |

Module 42 may store or have access to any number of such look-up tables for various combinations of relevant parameters. For example, module 42 may store a look-up table (similar to Table 1) for determining the jerk percentile. As another example, module 42 may store similar look-up tables for determining G-force and jerk percentiles for different combinations of vehicles, vehicle types, speed ranges, acceleration direction (lateral or longitudinal), etc.

At step 108, data processing module 42 may calculate a Base Driving Score for the data collection session, according to the following equation:

Base Driving Score=(AVG_G-force_percentile)*W1+(AVG_Jerk_percentile)*W2

wherein:
AVG_G-force_percentile is the average of the G-force percentiles for all time stamps Tᵢ during the data collection session;
AVG_Jerk_percentile is the average of the jerk percentiles for all time stamps Tᵢ during the data collection session; and
W1 and W2 are weighting constants used to weight the relative significance of G-force data and jerk data as desired.

As another example, the base driving score may be calculated according to the following equations:

Tᵢ Driving Score=min(100,250−(2*Tᵢ percentile))

Base Driving Score=average of all Tᵢ Driving Scores in which max G-force(lateral,longitudinal)<predefined minimal value.

wherein:
Tᵢ percentile is a percentile determined for each time stamp Tᵢ (e.g., G-force percentile, jerk percentile, or a weighted average of G-force percentile and jerk percentile for the time stamp Tᵢ);
Tᵢ Driving Score is a driving score for each time stamp Tᵢ; and
Tᵢ Driving Scores in which max G-force (lateral, longitudinal)<predefined minimal value indicates that data from time stamps in which the max (lateral, longitudinal) G-force is less than some predefined minimal value (e.g., 0.01) is excluded from the calculations. For example, due to the fact that g-forces may be less than some predefined minimal value (e.g., 0.01) at some or many time stamps (e.g., during highway cruise driving), as well as the issue of unstable g-force reading (below) a predefined minimal value, module 42 may ignore data from time stamps in which the max (lateral, longitudinal) G-force is less than the predefined minimal value.

At step 110, data processing module 42 may identify and analyze any notable driving events during the data collection session, based on the collected/processed G-force data and jerk data. For example, module 42 may compare the lateral and longitudinal G-force data to corresponding threshold values to identify the occurrence of notable driving events. For example, module 42 may execute the following example algorithms to identify the occurrence and type of a notable driving event (NDE) for a Chevrolet Impala:
lat_magnitude_gf=max(0, abs(LatG)−0.40);
lon_magnitude_gf=max(0, abs(LonG)−0.30);
magnitude_gf=max(lat_magnitude_gf, lon_magnitude_gf);
if magnitude_gf=lat_magnitude_gf and latG.>0 then NDE_type=“L”;
else if magnitude_gf=lat_magnitude_gf and latG.<=0 then NDE_type=“R”;
else if magnitude_gf=lon_magnitude_gf and lonG<0 then NDE_type=“A”;—
else if magnitude_gf=lon_magnitude_gf and lonG>=0 then NDE_type=“D”;
else no NDE identified.

wherein:
LatG=lateral G-forces detected by the accelerometer;
LonG=longitudinal G-forces detected by the accelerometer;
NDE_type “L”=Left Cornering
NDE_type “R”=Right Cornering
NDE_type “A”=Acceleration
NDE_type “D”=Deceleration

The threshold values used in such algorithms (e.g., the LatG and LonG threshold values 0.40 and 0.30 shown above) may be specific to one or more parameters, such that module 42 applies appropriate thresholds based on the parameter(s) relevant to the data being analyzed. For example, module 42 may store different threshold values for different types of vehicles. To illustrate an example, module 42 may store the following threshold values for three different vehicles: Impala, Camaro, and FordVan:
Impala (shown above)
   LatG threshold=0.40
   LonG threshold=0.30
Camaro
   LatG threshold=0.60
   LonG threshold=0.40
Ford Van
   LatG threshold=0.30
   LonG threshold=0.30

It should be understood that the threshold values shown above are examples only, and that any other suitable values may be used.

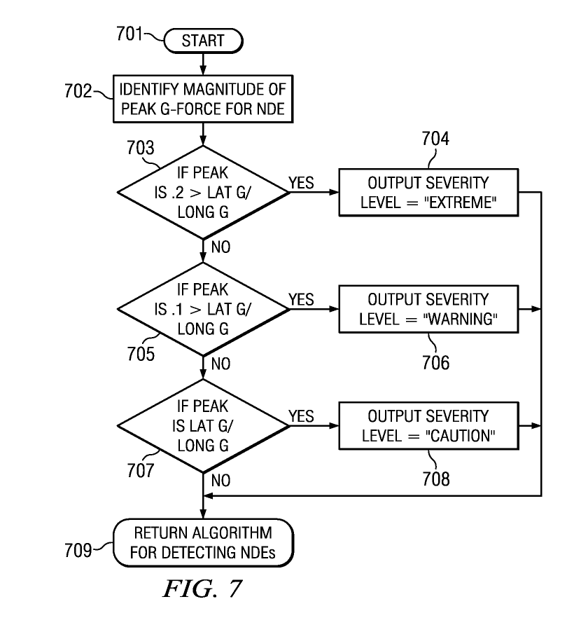

Data processing module 42 may further determine the severity level of each notable driving event (NDE) identified during the data collection session. For example, module 42 may execute the following algorithm to determine the severity level (e.g., caution, warning, or extreme) of each NDE (See FIG. 7):
start 701 the algorithm
identify 702 the G-force magnitude peak associated with the NDE;
if the G-force magnitude peak is at least 0.2 above the relevant LatG/LonG threshold 703, the NDE severity level is “extreme” 704;
else if the G-force magnitude peak is at least 0.1 above the relevant LatG/LonG threshold 705, the NDE severity level is “warning” 706;
else if the G-force magnitude peak is above the caution threshold 707, the NDE severity level is “caution” 708; and
return 709 to the algorithm for detecting NDEs.
   It should be understood that the threshold values shown above (0.2 and 0.1) are examples only, and that any other suitable values may be used.

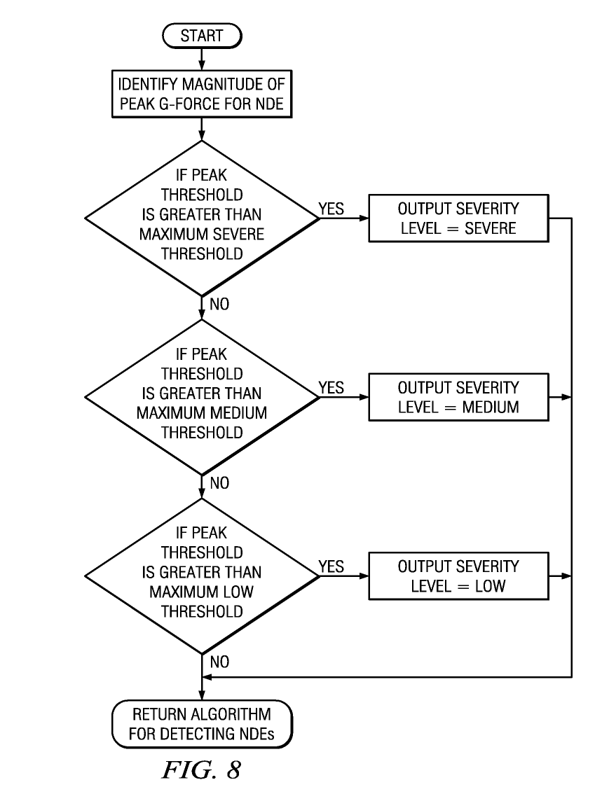

FIG. 8 is a flow chart of an alternative illustrative algorithm for determining severity levels of notable driving events (NDE) identified during data collection sessions. In this embodiment, the output severity levels are “severe,” “medium” and “low.”

Data processing module 42 may further “de-dupe” identified NDEs, i.e., eliminate or attempt to eliminate double counting (or more) of the same NDE. For example, module 42 may apply an algorithm that applies a 30 second rule for de-duping the same type of NDE (e.g., L, R, A, or D), and a 4 second rule for de-duping different types of NDEs. Thus, if multiple NDEs of the same type (e.g., two L-type events) are identified within a 30 second window, module 42 assumes that the same NDE is being counted multiple times, and thus treats the multiple identified NDEs as a single NDE. Further, if multiple NDEs of different types (e.g., one L-type event and one R-type event) are identified within a 4 second window, module 42 assumes that the same NDE is being counted multiple times, and thus treats the multiple identified NDEs as a single NDE, and applies any suitable rule to determine the NDE type that the NDE will be treated as (e.g., the type of the first identified NDE controls, or a set of rules defining that particular NDE types control over other NDE types).

It should be understood that the de-duping time limits shown above (30 seconds and 4 seconds) are examples only, and that any other suitable time limits may be used.

Referring again to FIG. 4, at step 112, data processing module 42 may calculate an Adjusted Driving Score for the data collection session, by adjusting the Base Driving Score certain values calculated at step 108 based on NDEs determined at step 110. For example, module 42 may deduct from the Base Driving Score based on the number, type, and/or severity level of NDEs determined at step 110. In some embodiments, only certain types and/or severity levels of NDEs are deducted from the Base Driving Score. For example, module 42 may execute the following algorithm, in which only “warning” and “extreme” level NDEs (but not “caution” level NDEs) are deducted from the Base Driving Score:
NDE Penalty for each NDE=50*(G-force−G-force_warning_threshold);
Adjusted Driving Score=Base Driving Score−sum(NDE Penalties)

It should be understood that this algorithm is an example only, and that any other suitable algorithms for determining an Adjusted Driving Score may be used.

At step 114, feedback module 44 may display any of the data collected by data collection module 40 at step 104 (e.g., raw data or filtered raw data) and/or any of the metrics, scores, or other data calculated or processed by data processing module 42 at steps 106-112. This may include any manner of “displaying” data as discussed above, e.g., displaying data on display device 36 on handheld mobile device 10, providing visual, audible, or other sensory feedback to the driver via handheld mobile device 10 or other device in the vehicle, communicating data to remote computer devices for remote display, etc. In some embodiments, feedback module 44 may facilitate user interaction with application 50 (e.g., via a touchscreen display 36 or other input devices 38) allowing the user to view any of the data discussed above, e.g., by user selection or navigation of displayed objects).

In some embodiments, feedback module 44 may generate a series of user-navigable screens, windows, or other objects for display on display device 36 on handheld mobile device 10. FIGS. 6A-6G discussed below illustrate example screen shots generated by an driving analysis application 50, according to example embodiments.

At step 116 (see FIG. 4), feedback module 44 may initiate and/or manage the storage of any of the data collected by data collection module 40 at step 104 (e.g., raw data or filtered raw data) and/or any of the metrics, scores, or other data calculated or processed by data processing module 42 at steps 106-112, such that the stored data may be subsequently accessed, e.g., for display or further processing. For example, feedback module 44 may store data in local volatile memory for display, in local non-volatile memory as historical driving data 46, and/or communicate data to remote devices 150 and/or remote driving data storage 152.

As discussed above, in some embodiments, driving data collected by application 50 may be used by various third parties for various purposes. Thus, for example, at step 118, an insurance provider may receive or access driving behavior metrics and/or driving scores collected by application 50 (e.g., by receiving or accessing historical driving data 46 directly from handheld mobile device 10 and/or by receiving or accessing historical driving data 152 from external storage), and analyze such data for performing risk analysis of the respective driver. The insurance provider may determine appropriate insurance products or premiums for the driver according to such risk analysis.

FIG. 5 illustrates an example system 140 for sharing driving data between a handheld mobile device 10 including driving analysis application 50 and other external systems or devices, according to certain embodiments. As shown, handheld mobile device 10 may be communicatively connected to one or more remote computers 150 and/or remote data storage systems 152 via one or more networks 144.

Computers 150 may include any one or more devices operable to receive driving data from handheld mobile device 10 and further process and/or display such data, e.g., mobile telephones, personal digital assistants (PDA), laptop computers, desktop computers, servers, or any other device. In some embodiments, a computer 150 may include any suitable application(s) for interfacing with application 50 on handheld mobile device 10, e.g., which application(s) may be downloaded via the Internet or otherwise installed on computer 150.

In some embodiments, one or more computers 150 may be configured to perform some or all of the data processing discussed above with respect to data processing module 42 on handheld mobile device 10. Such a computer may be referred to herein as a remote processing computer. For example, handheld mobile device 10 may communicate some or all data collected by data collection module 40 (raw data, filtered data, or otherwise partially processed data) to a remote processing computer 150, which may process (or further process) the received data, e.g., by performing any or all of the driver data processing discussed above with respect to data processing module 42, and/or additional data processing. After processing the data, computer 150 may then communicate the processed data back to handheld mobile device 10 (e.g., for storage and/or display), to other remote computers 150 (e.g., for storage and/or display), and/or to remote data storage 152. The data processing and communication of data by computer 150 may be performed in real time or at any other suitable time. In some embodiments, computer 150 may process driving data from handheld mobile device 10 and communicate the processed data back to handheld mobile device 10 such that the data may be displayed by handheld mobile device 10 substantially in real time, or alternatively at or shortly after (e.g., within seconds of) the completion of a driving data collection session.

Using one or more computers 150 to perform some or all of the processing of the driving data may allow for more processing resources to be applied to the data processing (e.g., thus providing for faster or additional levels of data processing), as compared to processing the data by handheld mobile device 10 itself. Further, using computer(s) 150 to perform some or all of the data processing may free up processing resources of handheld mobile device 10, which may be advantageous.

Remote data storage devices 152 may include any one or more data storage devices for storing driving data received from handheld mobile device 10 and/or computers 150. Remote data storage 152 may comprise any one or more devices suitable for storing electronic data, e.g., RAM, DRAM, ROM, flash memory, and/or any other type of volatile or non-volatile memory or storage device. A remote data storage device 152 may include any suitable application(s) for interfacing with application 50 on handheld mobile device 10 and/or with relevant applications on computers 150.

Network(s) 144 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data) via any one or more wired and/or wireless communication links.

FIGS. 6A-6G illustrate example screen shots generated by driving analysis application 50 on an example handheld mobile device 10, according to certain embodiments.

FIG. 6A illustrates an example screenshot of a screen 200 of a device orientation feature provided by application 50 for assisting a user with the proper alignment or orientation of handheld mobile device 10 within the automobile or vehicle. In this example, an alignment image 202 may indicate the physical orientation (e.g., angular orientation) of handheld mobile device 10 relative to the automobile. For example, alignment image 202 may rotate relative to the rest of the display as handheld mobile device 10 is reoriented. Alignment image 202 may include arrows or other indicators to assist the use in orienting handheld mobile device 10. An indicator 204 (e.g., a lighted icon) may indicate when handheld mobile device 10 is suitably oriented for data collection, e.g., with the front of handheld mobile device 10 facing toward the front of the automobile or vehicle.

In embodiments requiring manual starting of data recording (i.e., starting a data collection session), a screen or image for starting data recording may appear upon the handheld mobile device 10 being properly oriented. Thus, data collection module 40 may then start (or re-start) collection of driving data upon a manual instruction (e.g., a user pressing a “Start Recording” button that is displayed on display 36 once handheld mobile device 10 is properly oriented).

In embodiments that provide for automatic starting of data recording (i.e., starting a data collection session), data collection module 40 may start (or re-start) driving data collection automatically upon the proper orientation of handheld mobile device 10, or automatically in response to an automatically generated triggering signal (assuming handheld mobile device 10 is properly oriented).

FIG. 6B illustrates an example screenshot of a screen 210 during a data collection session. The display may indicate that driving data is being recorded (image 212) and may provide a selectable image 214 for stopping the recording of driving data (i.e., ending the data collection session).

FIG. 6C illustrates an example screenshot of a summary screen 218 for a single data collection session, including three driving behavior metrics (Acceleration, Braking, and Cornering) and a driving score (“224”) calculated by data processing module 42 for the single data collection session. For the illustrated data collection session, the driving score 224 calculated to be “82.” The metrics and score may be displayed in real time (e.g., evaluating the driving behavior during an ongoing trip), after conclusion of a trip (e.g., evaluating the completed trip or a group of trips), or at any other time. As shown, screen 218 includes values 220 and corresponding bar graphs 222 indicating the Acceleration, Braking, and Cornering metrics, as well a visual representation 224 of the driving score (“82”) calculated by data processing module 42. The driving score may be calculated based on the Acceleration, Braking, and Cornering metrics using any suitable algorithm. For example, the driving score may be a straight or weighted average of the metrics, a sum or weighted sum of the metrics, or any other representation. The algorithm for calculating the driving score may also account for data other than the metrics, such as the identity of the driver, the time, duration, and/or distance of the data collection session, the weather conditions, traffic conditions, and/or any other relevant data accessible to data processing module 42.

FIG. 6D illustrates an example screenshot of a summary screen 230 for a group of multiple data collection sessions, including three multi-session driving behavior metrics (Acceleration, Braking, and Cornering) and a multi-session driving score (“78”) calculated by data processing module 42 for the group of data collection sessions. Each multi-session driving behavior metric, as well as the driving score, for the group of sessions may be calculated based on any number of data collection sessions, and using any suitable algorithm. For example, each multi-session metric/score may be an average (e.g., straight or weighted average) of the respective metrics/scores determined for the n most recent data collection sessions. Further, the multi-session metric/score may be filtered according to preset or user-selected criteria. For example, each multi-session metric/score may be an average (e.g., straight or weighted average) of the respective metrics/scores determined for the n most recent data collection sessions that meet one or more preset or user-selected criteria regarding the respective data collection session, e.g., the particular driver, time of day, trip distance, trip duration, geographic area of travel, weather conditions, traffic conditions, or any other relevant data accessible to data processing module 42. Thus, for instance, module 42 may calculate multi-session driving behavior metrics and driving scores for the five most recent trips by Bob, which were further than 3 miles, within the geographic limits of a particular city, and during good weather conditions.

The number of data collection sessions included in a particular multi-session driving metric/score may be automatically or manually selected in any suitable manner, e.g., a predetermined number of sessions, a number automatically determined by module 42 (e.g., all sessions occurring within a predetermined time period), a number manually selected by a user, or determined in any other manner.

In embodiments in which particular multi-session driving metrics/scores represent weighted averages, each individual-session metric (e.g., each individual-session Braking metric) to be averaged into a weighted average may be weighted based on recentness (e.g., based on the elapsed time since that session, or the sequential order position of that session (e.g., the 3^{rd} most recent session)), trip duration, trip distance, or any other relevant criteria accessible to data processing module 42. Thus, for instance, the weighting of each individual-session metric to be averaged into a weighted average may be weighted proportionally according to the number of days since each respective session, such that a trip that occurred 20 days ago is weighted twice as much as a trip that occurred 20 days ago. As another example, the 1^{st} most recent, 2^{nd} most recent, 3^{rd} most recent, and 4^{th} most recent sessions may be assigned predefined weighting factors of 0.50, 0.30, 0.15, 0.05, respectively. As another example, a 6-mile trip may be weighted the same as, or twice as much, as a 3-mile trip, depending on the specific embodiment. As another example, a 30-minte trip may be weighted the same as, or three times as much, a 10-minute trip, depending on the specific embodiment.

Alternatively, instead of displaying the average of the metrics/scores determined for a group of data collection sessions, summary screen 230 may display the median value for particular metrics/scores. Thus, for example, summary screen 230 may display for each metric the median value for that metric over the last seven trips. As another alternative, summary screen 230 may display the lowest or highest value for particular metrics/scores. Thus, for example, summary screen 230 may display for each metric the lowest value for that metric over the last seven trips.

It should be understood that multi-session driving metrics/scores may be determined using any combination of techniques or algorithms discussed above, or using any other suitable techniques or algorithms.

FIG. 6E illustrates an example screenshot of a screen 240 summarizing various data for each of multiple data collection sessions. In this example, screen 240 indicates for each data collection session for a particular driver: a trip description (manually entered by a user or automatically determined by module 42, e.g., based on GPS data), trip date, trip time (e.g., session start time, end time, or midpoint), and driving score (indicated by a bar graph and numerical value). In addition to or instead of displaying the driving score for each session, screen 240 may display one or more driving behavior metrics for each session, and/or other data relevant to each session (e.g., weather conditions, traffic conditions, trip distance, trip duration, etc.). Any number of sessions may be displayed, and the particular sessions that are displayed may be filtered, e.g., according to any of the criteria discussed above. In the illustrated example, the user may scroll down on screen 240 to view data for additional sessions.

FIG. 6F illustrates an example screenshot of a screen 250 in which multiple trips can be compared. In this example, two trips by the same driver are compared. However, trips by different drivers may similarly be compared. The trips being compared may be selected by a user, or automatically selected by module 42 based on any suitable criteria. The compare function may be used to test drivers against a particular test course. For example, a driver education instructor could collect driving behavior metrics for himself by driving a test course. Later, students could collect driving behavior metrics while driving the same test course as previously driven by the instructor. The driving behavior metrics of the instructor could then be used as a standard against which to compare the driving behavior metrics of the students.

FIG. 6G illustrates an example screenshot of a map screen 260, indicating the path 262 of a recorded trip, which may be generated based on data collected by location tracking system 56 (e.g., GPS data). Screen 260 may also display icons 264 indicating the locations of notable driving events (NDEs). Such icons 264 may indicate the type and/or severity level of each NDE. In the illustrated example, the type of NDE (e.g., type “L”, “R”, “A”, or “D”) is indicated by the shape of the respective icon 264, and the severity level of the NDE is indicated by the color of the icon 264, indicated in FIG. 6G by different shading. In some embodiments, the user may select a particular icon 264 to display (e.g., via a pop-up window or new screen) additional details regarding the respective NDE.

It should be understood that application 50 may generate any number of additional screens for displaying the various information collected or processed by application 50.

Embodiments of the invention may be used in a variety of applications. For example, a driver feedback handheld mobile device could be used to proctor a driver's test for a candidate to obtain a driver's license. It may be used to educate drivers about how to drive in ways that promote better fuel efficiency. The invention may be used to leverage smart phones to quantify and differentiate an individual's insurance risk base on actual driving behaviors and/or driving environment. The invention may be used to provide data that could be used as a basis to provide a potential customer a quote for insurance. Embodiments of the invention may be used by driver education instructors and systems to educate drivers about safe driving behaviors.

Although the disclosed embodiments are described in detail in the present disclosure, it should be understood that various changes, substitutions and alterations can be made to the embodiments without departing from their spirit and scope.

What is claimed is:

1. A system for collecting and evaluating driving related data, comprising:
a handheld mobile device, including;
one or more sensors associated with the handheld mobile device and configured to automatically collect driving data during a data collection session;
a processor;
a non-transitory storage medium;
a display device; and
a set of computer readable instructions stored in the non-transitory storage medium and when executed by the processor configured to:
calculate, based at least on the collected driving data, one or more metrics related to the driver's driving behavior; and
display on the display device the one or more calculated metrics related to the driver's driving behavior.

2. A system for collecting and evaluating driving related data as claimed in claim 1, wherein the set of computer readable instructions stored in the non-transitory storage medium, when executed by the processor, are configured to:
automatically collect the driving data during multiple separate data collection sessions, each corresponding to a separate driving session;
calculate, based on driving data collected during an individual data collection session corresponding to an individual driving session, at least one metric related to the driver's driving behavior during the individual driving session; and
display on the display device the at least one calculated metric related to the driver's driving behavior during the individual driving session.

3. A system for collecting and evaluating driving related data as claimed in claim 1, wherein the set of computer readable instructions stored in the non-transitory storage medium, when executed by the processor, are configured to:
collect the driving data during multiple separate data collection sessions, each corresponding to a separate driving session;
combine the driving data collected during the multiple data collection sessions; and
calculate, based on the combined driving data collected during the multiple data collection sessions corresponding to multiple driving sessions, at least one metric related to the driver's driving behavior during the multiple driving sessions.

4. A system for collecting and evaluating driving related data as claimed in claim 1, wherein the set of computer readable instructions stored in the non-transitory storage medium, when executed by the processor, are configured to:
calculate, based on the combined driving data collected during the multiple data collection sessions corresponding to multiple driving sessions, an averaged value of a particular metric for the multiple driving sessions; and
display the averaged value of the particular metric for the multiple driving sessions.

5. A system for collecting and evaluating driving related data as claimed in claim 1, wherein the one or more sensors associated with a handheld mobile device comprises an accelerometer, and wherein the set of computer readable instructions stored in the non-transitory storage medium, when executed by the processor, are configured to:
calculate one or more metrics related to the driver's driving behavior, the metrics being at least one of:
an acceleration metric indicative of the vehicle acceleration;
a braking metric indicative of the vehicle braking; and
a cornering metric indicative of the vehicle cornering.

6. A system for collecting and evaluating driving related data as claimed in claim 1, wherein the set of computer readable instructions stored in the non-transitory storage medium, when executed by the processor, are configured to:
collect the driving data during multiple separate data collection sessions corresponding to multiple separate driving sessions;
for each driving session, calculate a particular metric related to the driver's driving behavior;
display on the display device the calculated particular metric for each of the multiple driving sessions.

7. A system for collecting and evaluating driving related data as claimed in claim 1, wherein the set of computer readable instructions stored in the non-transitory storage medium, when executed by the processor, are configured to:
calculate multiple individual metrics related to the driver's driving behavior;
calculate an overall score based on the multiple different metrics;
display on the display device (a) the multiple calculated individual metrics and (b) the calculated overall score.

8. A system for collecting and evaluating driving related data as claimed in claim 1, wherein the set of computer readable instructions stored in the non-transitory storage medium, when executed by the processor, are configured to:
collect the driving data during multiple separate data collection sessions corresponding to multiple separate driving sessions;
for each driving session:
calculate, based at least on the driving data collected during that driving session, multiple different metrics related to the driver's driving behavior during that driving session; and
calculate an overall score for that driving session based on the multiple different metrics calculated for that driving session; and
display on the display device the calculated overall score for each of the multiple driving sessions.

9. A system for collecting and evaluating driving related data as claimed in claim 1, wherein the set of computer readable instructions stored in the non-transitory storage medium, when executed by the processor, are configured to automatically notify the driver to set or adjust the physical orientation of the handheld mobile device before or during collection of the driving data.

10. A system for collecting and evaluating driving related data as claimed in claim 1, wherein the set of computer readable instructions stored in the non-transitory storage medium, when executed by the processor, are configured to analyze the collected driving data to identify notable driving events occurring during the data collection session.

11. A system for collecting and evaluating driving related data as claimed in claim 1, wherein the set of computer readable instructions stored in the non-transitory storage medium, when executed by the processor, are configured to:
calculate multiple different metrics related to the driver's driving behavior during the data collection session; and
calculate an overall score for the data collection session based on (a) the multiple different metrics calculated for that driving session and (b) notable driving events identified for the data collection session.

12. A system for collecting and evaluating driving related data as claimed in claim 1, wherein the set of computer readable instructions stored in the non-transitory storage medium, when executed by the processor, are configured to analyze the collected driving data to identify notable driving events occurring during the data collection session by:
comparing driving data collected during particular events within the data collection session with one or more predefined thresholds; and
identifying the presence of notable driving events based on the comparisons.

13. A system for collecting and evaluating driving related data as claimed in claim 10, wherein the set of computer readable instructions stored in the non-transitory storage medium, when executed by the processor, are configured to:
display a map indicating a path traveled during the data collection session; and
indicate the location of one or more identified notable driving events along the displayed travel path on the displayed map.

14. A method for collecting and evaluating driving related data, comprising:
using one or more sensors associated with a handheld mobile device to automatically collect driving data during a data collection session;
using one or more processors to execute computer readable instructions stored in non-transitory memory to:
calculate, based at least on the collected driving data, one or more metrics related to the driver's driving behavior; and
display on a display device the one or more calculated metrics related to the driver's driving behavior.

15. A method according to claim 14, further comprising:
automatically collecting the driving data during multiple separate data collection sessions, each corresponding to a separate driving session;
calculating, based on driving data collected during an individual data collection session corresponding to an individual driving session, at least one metric related to the driver's driving behavior during the individual driving session; and
displaying on the display device the at least one calculated metric related to the driver's driving behavior during the individual driving session.

16. A method according to claim 14, further comprising:
collecting the driving data during multiple separate data collection sessions, each corresponding to a separate driving session;
combining the driving data collected during the multiple data collection sessions; and
calculating, based on the combined driving data collected during the multiple data collection sessions corresponding to multiple driving sessions, at least one metric related to the driver's driving behavior during the multiple driving sessions.

17. A method according to claim 16, comprising:
calculating, based on the combined driving data collected during the multiple data collection sessions corresponding to multiple driving sessions, an averaged value of a particular metric for the multiple driving sessions; and
displaying the averaged value of the particular metric for the multiple driving sessions.

18. A method according to claim 14, wherein:
the one or more sensors associated with a handheld mobile device include an accelerometer; and
calculating one or more metrics related to the driver's driving behavior includes calculating at least one of:
an acceleration metric indicative of the vehicle acceleration;
a braking metric indicative of the vehicle braking; and
a cornering metric indicative of the vehicle cornering.

19. A method according to claim 14, comprising:
collecting the driving data during multiple separate data collection sessions corresponding to multiple separate driving sessions;
for each driving session, calculating a particular metric related to the driver's driving behavior;
displaying on the display device the calculated particular metric for each of the multiple driving sessions.

20. A method according to claim 14, comprising:
calculating multiple individual metrics related to the driver's driving behavior;
calculating an overall score based on the multiple different metrics;
displaying on the display device (a) the multiple calculated individual metrics and (b) the calculated overall score.

21. A method according to claim 14, comprising:
collecting the driving data during multiple separate data collection sessions corresponding to multiple separate driving sessions;
for each driving session:
calculating, based at least on the driving data collected during that driving session, multiple different metrics related to the driver's driving behavior during that driving session; and
calculating an overall score for that driving session based on the multiple different metrics calculated for that driving session; and
displaying on the display device the calculated overall score for each of the multiple driving sessions.

22. A method according to claim 14, further comprising the handheld mobile device automatically notifying the driver to set or adjust the physical orientation of the handheld mobile device before or during collection of the driving data.

23. A method according to claim 14, further comprising:
analyzing the collected driving data to identify notable driving events occurring during the data collection session.

24. A method according to claim 23, further comprising:
calculating multiple different metrics related to the driver's driving behavior during the data collection session; and
calculating an overall score for the data collection session based on (a) the multiple different metrics calculated for that driving session and (b) notable driving events identified for the data collection session.

25. A method according to claim 23, wherein identifying notable driving events includes:
comparing driving data collected during particular events within the data collection session with one or more predefined thresholds; and
identifying the presence of notable driving events based on the comparisons.

26. A method according to claim 23, further comprising:
displaying a map indicating a path traveled during the data collection session;
indicating the location of one or more identified notable driving events along the displayed travel path.

27. A non-transitory computer readable medium containing a set of computer readable instructions executable by a processor to:
receive driving data collected by one or more sensors associated with a handheld mobile device during a data collection session;
calculate, based at least on the collected driving data, one or more metrics related to the driver's driving behavior; and
display on a display device the one or more calculated metrics related to the driver's driving behavior.
